(19) United States
(12) Patent Application Publication
(10) Pub. No.: US 2017/0323166 A1
(43) Pub. Date: Nov. 9, 2017

(54) SMARTCARD AND METHOD FOR CONTROLLING A SMARTCARD

(71) Applicant: Zwipe AS, Oslo (NO)

(72) Inventors: Steven Colussi, Colorado Sprinags, CO (US); Kim Kristian Humborstad, Oslo (NO); Steffen Larsen, Oslo (NO)

(21) Appl. No.: 15/474,066

(22) Filed: Mar. 30, 2017

Related U.S. Application Data
(60) Provisional application No. 62/332,585, filed on May 6, 2016.

(30) Foreign Application Priority Data
Jun. 1, 2016 (GB) 1609572.1

(51) Int. Cl. G06K 9/00; G06K 19/07

(52) U.S. Cl. CPC G06K 9/00892; G06K 19/0723; G06K 9/00013; G06K 9/00335; G06K 9/00926

(57) ABSTRACT

A smart card 102 may include a processor for controlling operation of the smartcard, a biometric sensor for identification of an authorised user, and an accelerometer for sensing movements of the smartcard. The processor may be arranged to permit access to one or more secure feature(s) of the smartcard based on the movements sensed by the accelerometer and authentication of the user's identity via the biometric sensor.

### TECHNICAL FIELD

The present invention relates to a smartcard having one or more secure feature(s), to a method and a computer programme product for controlling such a smartcard, and to a method of manufacturing such a smart card.

### BACKGROUND OF THE INVENTION

Smartcards are becoming increasingly more widely used and include, for example access cards, credit cards, debit cards, pre-pay cards, loyalty cards, identity cards, cryptographic cards, and so on. Smartcards are electronic cards with the ability to store data and to interact with the user and/or with outside devices, for example via contactless technologies such as RFID. These cards can interact with readers to communicate information in order to enable access, to authorise transactions and so on.

Biometric authorisation such as fingerprint authorisation is becoming increasingly more widely used. Smartcards with biometric authorisation can interact with the user via sensors in order to enable access to secure features of the smartcard, for example in order to authorise financial transactions.

### SUMMARY OF THE INVENTION

Viewed from a first aspect the present invention provides a smartcard comprising: a processor for controlling operation of the smartcard; a biometric sensor for identification of an authorised user; and an accelerometer for sensing movements of the smartcard; wherein the processor is arranged to permit access to one or more secure feature(s) of the smartcard based on the movements sensed by the accelerometer and authentication of the user's identity via the biometric sensor.

This smartcard provides additional functionality for a biometric card, as well as an additional layer of security, by allowing interaction between the user and the smartcard using movements or gestures by a user holding or touching the card to be used to protect certain features of the card. The secure feature(s) of the card may for example include authorisation of a transaction for a bank card. A multilayer authentication as in the first aspect will more securely protect the secure feature(s) since multiple fraudulent acts will be needed in order to hack both a biometric and a movement sensing based authentication. Even if it is possible to somehow trick the smartcard into authentication of a user based on some kind of biometric fraud, for example a falsified fingerprint, this would not allow the fraudster to subvert the movement based authentication layer. Conversely, if the fraudster can somehow mimic the movement sequence, or trick the processor into believing that it has received the right output from the accelerometer, the biometric authentication layer should still protect the secure features of the smartcard.

The accelerometer measures a vibrational/movement pattern that is specific to the sequence selected by the user. The processor may be arranged to receive and record a movement pattern that is to be enrolled to the smartcard. Alternatively or additionally the accelerometer output data produced by the movement pattern may be transmitted from the card during enrolment and recorded in an external database. The processor may be arranged to permit access to the one or more secure feature(s) when both of the movements sensed by the accelerometer are determined to be a match with an enrolled movement pattern and there is authentication of the user's identity via the biometric sensor.

The output of the accelerometer is unique to the sequence of movements made by the user, and also unique to the smartcard. Each smartcard will have its own natural frequency as well as reacting dynamically to interactions of the user with the card in a different way to other cards. For example, a stiffer card will move differently after the user waves or taps the card than a more flexible card. Thus, it is important to understand that movements of the card that are detected by the accelerometer will include the effects of the dynamic reaction of the smartcard. The discussion herein of movements detected by the accelerometer should be understood in that context. The output signal (i.e. the accelerometer output data) from the accelerometer is a representation of the dynamic reaction of the smartcard as well as the movements that are made.

Since the accelerometer output data is specific to both the user and the card, then the data cannot be duplicated. If a “fake” card is produced and the tap sequence data is “injected” into the microprocessor, the dynamic reaction of the new card will be different from the original card, so therefore it cannot be hacked by mimicking the movement pattern. In the case of smartcards that are mass produced then it is likely that tolerances and inevitable small variations in the construction of the smartcards will lead to differences in the characteristics of the movements of the smartcard. To enhance the distinctions between mass produced smart cards manufactured using the same basic process then the manufacturing method may include varying the location of the accelerometer and/or adding mass/stiffness elements with differing characteristics to the cards so that each individual card has a fully unique movement pattern. Thus, the smartcard may include an added mass or stiffness element in some examples. If another user tries to use the original card by following the owner's tap sequence, the manner in which the fraudulent user holds the card (for example, after successfully creating a false biometric acceptance), and his/her tapping mannerisms will also create a different resonance.

The use of movements sensed by the accelerometer can also allow for alternative card features to be activated without the need for manipulation of input devices on the card such as buttons or other sensors needing direct physical contact. The movements sensed by the accelerometer may be used to activate various operating modes of the card. Advantageously the smartcard is a contactless card and thus the user can switch between different modes as well as using the card via card readers with the only contact being holding of the card by the user. This can allow for increased features and increased complexity in how the smartcard is used, without detriment to the ease of operation of the card.

The movements of the smartcard sensed by the accelerometer may include rotation of the smartcard in one or more directions (clockwise/anticlockwise) and/or in one or more than one axis of rotation, translation of the smartcard in one or more directions (forward/backward) and along one or more axis, and/or accelerations in one or more directions (forward/backward) and along one or more axis as well as jerk or impulses in one or more directions (forward/backward) and along one or more axis. Combinations of these movements may also be detected. For example a “tapping” of the smartcard on a hard surface will expose the card to acceleration as the user begins to move the card and then an impulse as the card hits the surface. A user might also hold the card in one hand and tap it with the other hand. Again this produces a combination of movements. Another possibility is a “flick” motion of the card including a combination of translation and acceleration/deceleration to characterise the movement detected by the accelerometer. The axes referenced above may for example be x, y, z axes aligned with the long side of the card, the short side of the card, and the normal to the card.

Rotations of the smartcard sensed by the accelerometer may include changes in orientation of the smartcard, for example switching from portrait to landscape orientation or turning the card over. The rotations may include 90 degree turns, 180 degree turns, 270 degree turns or 360 degree turns, or intervening values, in any direction.

Translational movements may include waving motions, optionally in combination with acceleration/deceleration as with a flicking type motion, or a tapping motion of the card on a surface, or tapping of a finger on the card, for example.

The accelerometer may also be arranged to detect a free fall movement, for example when the card is dropped. The use of accelerometers to detect free fall is well-established and is used, for example, to activate safety features of hard disk drives to prevent damage when they are dropped.

The processor may be arranged to identify the movements of the card based on the output of the accelerometer, and to change the operating mode of the smartcard in response to pre-set movements. The pre-set movements may include any or all movements discussed above. In addition, the processor may determine the length of a time period without motion, i.e. a time period indicative of no active usage of the smartcard, and this may also be used to change the operating mode of the smartcard and/or to deactivate features, such as a secure feature, that are currently activated. The processor may also be arranged to identify repeated movements or sequences of movements, such as a double tap, or a translational movement followed by a rotation such as a sliding and twisting motion.

Advantageously, the smartcard may be arranged to allow the user to set their own movements and or combinations of movements, and in particular the smartcard may be arranged so that the user can enroll a movement pattern for use in authentication of the user's identity as a part of the activation process for the secure feature(s). For example the processor may have a learn mode where the accelerometer output data from a combination of movements by the user can be taught to the processor and then allocated to a specific change in the operating mode of the smartcard, and/or used in the authorisation of access to the one or more secure feature(s) of the smartcard. This can provide for increased security by the use of movements that may be unique to each individual.

A preferred arrangement requires a combination of biometric authorisation and matching of a movement pattern to an enrolled movement pattern before secure features of the card are activated. It will be appreciated that the features of the card that are designated as secure features might vary and indeed could depend on the level of risk that the user or issuer of the card is prepared to take. Thus, in some examples any of the operating modes described herein could be selected as a secure feature or as secure features.

The operating modes of the smartcard that are controlled by movements sensed by the accelerometer may be related to a high level function, for example turning the card on or off, activating secure features of the card such as contactless payment (this may also require biometric authorisation), or changing the basic functionality of the card for example by switching between operating as an access card, a payment card, a transportation smartcard, switching between different accounts of the same type (e.g. two bank accounts) and so on.

Alternatively or additionally the operating modes of the smartcard that are controlled by movements sensed by the accelerometer may concern more specific functionalities of the smartcard, for example switching between communications protocols (such as blue tooth, Wifi, NFC) and/or activating a communication protocol, activating a display such as an LCD or LED display or obtaining an output from the smartcard, such as a one-time-password or the like.

Alternatively or additionally the operating modes of the smartcard that are controlled by movements sensed by the accelerometer may include prompting the card to automatically perform a standard operation of the smartcard. Examples of such standard operations might include a pre-set cash withdrawal in response to a specific movement during or prior to communication with an ATM, entering into a learning or set-up mode, PIN activation of the card (i.e. movements used in place of a PIN entry via a keypad), sending a message to a card reader or a smartphone and so on.

The processor may be arranged to allow for the user to specify which movements (including combinations of movements) should activate particular operating modes. The processor may use different movements for each one of a set of operating modes, or alternatively it may cycle through the operating modes of a set of operating modes in response to a repeated movement.

Examples of combinations of movements and changes in the operating mode of the smartcard include: flicking the card to switch the card application between, for example, access card, payment card, transport system card, turning on the card via a pre-set (preferably user specified) activation gesture, turning the card 180 degrees to switch between blue tooth and NFC, double tap on a surface to activate a display and so on.

One example includes placing the smartcard into a dropped card mode when free fall is detected. This mode may require reauthorisation via a security feature after the card has been picked up before further use of the card is permitted, or before full use of the card is permitted. This can ensure that a dropped card cannot be fraudulently used if found by an unauthorised user. The security feature may include use of a PIN at a card reader (i.e. for a payment card there might be no authorisation for an automatic transaction via contactless payments until PIN authorisation), a combination of movements acting as a PIN, and/or authorisation via other security features on the smartcard itself such as biometric authorisation as discussed below.

The smartcard may enter a dormant/off mode and require re-activation or re-authorisation for continued use after it has been left unused for a period of time, for example for several days or several weeks depending on the application. A re-activation may require a specific sequence of movements to be detected, or activation via interaction with a reader. A reauthorisation may be as discussed above in relation to the dropped card mode.

Although movements can be detected by an accelerometer with a single sensing axis, it is preferred to be able to detect accelerations in all directions. This may be done via multiple accelerometers, but preferably a single accelerometer is used that can detect acceleration in all directions, such as a tri-axis accelerometer.

The accelerometer is may be a micro-machined accelerometer such as a MEMS accelerometer. Alternatively a piezoelectric sensor may be used, such as a dedicated piezoelectric accelerometer or another piezoelectric sensor that can sense accelerations (e.g. a piezoelectric sounder or microphone). The use of these types of devices allows for them to be installed on a smartcard without the need for increasing the size of the smartcard. They also have low power consumption, which can be another design restriction for smartcards. Piezoelectric sensors may advantageously be incorporated into the device in such a way that there is zero power consumption until an input is detected by the piezoelectric sensor. The accelerometer may use a sense element such as a micro-machined cantilever or seismic mass. In an example implementation the acceleration sensing is based on the principle of a differential capacitance arising from acceleration-induced motion of the sense element. A possible accelerometer that could be used is a Tri-axis Digital Accelerometer such as those provided by Kionix, Inc. of Ithaca, N.Y., USA. An example embodiment uses the Kionix KXCJB-1041 accelerometer.

The smartcard may be capable of wireless communication, such as using RFID or NFC communication. Alternatively or additionally the smartcard may comprise a contact connection, for example via a contact pad or the like such as those used for “chip and pin” cards. In various embodiments, the smartcard may permit both wireless communication and contact communication.

The processor may also be arranged for enrolment of biometric data via the biometric sensor. This may be a fingerprint sensor, which is preferably embedded into the card. With this feature the authorised user may initially enroll their fingerprint onto the actual card, and may then be required to place their finger or thumb on the fingerprint sensor in order to authorise some or all uses of the card. A fingerprint matching algorithm on the processor may be used to identify a fingerprint match between an enrolled user and a fingerprint sensed by the fingerprint sensor.

A biometric sensor may be used to activate subsequent control of the card by movements, or to activate features denoted as higher security, such as a payment or withdrawal with a payment/bank card, or access to more secure areas when the smartcard is an access card. A biometric authorisation is preferably required in addition to a particular movement pattern of the card in order to complete a more secure operation.

In some cases a biometric authorisation may fail or may not be possible. For example in the case of a fingerprint sensor the user's fingerprints may be damaged by injury, or covered up. The sensor may also be damaged or might otherwise be inoperable. In this case the smartcard may advantageously allow for a pre-set, and preferably complex, movement acting as a back-up for biometric authorisation. The complex movement may be a motion sequence that includes two or more movements, for example three, four or five movements such as rotations, translations and so on. Preferably the pre-set movement is user defined and hence may be unique to the user.

A situation that can arise with some forms of biometric sensors and fingerprint sensors in particular is a failure to enroll. This is a fundamental issue with a small percentage of the population, who have fingerprints or other biometric characteristics that for some reason cannot be registered using the known biometric sensors. For fingerprints such failures are usually caused by missing or weak characteristics, such as missing fingers, faint fingerprints as well as damaged fingers. A system providing an alternative to biometric enrolment would also allow the use of biometric cards by those users who would just rather not have their biometric details recorded. The movement sensed by the accelerometer can be used as a non-biometric alternative for a biometric card so that people can still access the system or service without using the biometric system. In this case, a smartcard including a biometric sensor as well as the accelerometer may be provided with the ability to enroll via movements sensed by the accelerometer as an alternative to biometric data. The user may set a movement or sequence of movements for authorisation of the use of the card, such as a complex movement of the type discussed above. This may be the sole purpose of the sensed movements and/or sensed movements may also be used for changing the card between further different operating modes.

The smartcard may be any one of: an access card, a credit card, a debit card, a pre-pay card, a loyalty card, an identity card, a cryptographic card, or the like. The smartcard preferably has a width of between 85.47 mm and 85.72 mm, and a height of between 53.92 mm and 54.03 mm. The smartcard may have a thickness less than 0.84 mm, and preferably of about 0.76 mm (e.g. ±0.08 mm). More generally, the smartcard may comply with ISO 7816, which is the specification for a smartcard.

Where a processor is referred to herein it should be understood that this may include multiple processors working together. For example, the biometric sensor and/or the accelerometer may be provided with a dedicated processor that interacts with a further processor that has control of other features of the smartcard. Moreover, whilst in the preferred embodiment it is said that there is a processor that controls communications with the card as well as a fingerprint processor that is a part of the fingerprint authentication engine, it should be appreciated that these two processors may be each made up of multiple processors or could be separate software modules of a single combined processor.

Viewed from a second aspect, the invention provides a method for controlling a smartcard, the smartcard comprising: a processor for controlling operation of the smartcard; a biometric sensor for identification of an authorised user; and an accelerometer for sensing movements of the smartcard, wherein the method comprises: detecting movements of the smartcard using the accelerometer and the processor, identifying an authorised user of the smartcard via the biometric sensor, and permitting access to one or more secure feature(s) of the smartcard based on the movements sensed by the accelerometer and authentication of the user's identity via the biometric sensor.

The method may include use of a smartcard with features as discussed above in relation to the first aspect. The detected movements may be as discussed above and/or the secure feature(s) or operating modes may be as discussed above.

The method may include allowing the user to specify which movements (including combinations of movements) should activate particular operating modes.

The user may enroll biometric data and/or movement pattern data to the card, and thus the method may include using an enrolment mode of the processor and recording biometric data and/or movement pattern data during the enrolment mode, with the recorded data being used for later matching with data provided by the biometric sensor and/or the accelerometer during authentication of the user.

The method may include the use of a sequence of movements in place of biometric authorisation, for example to allow for use of some or all operating modes of the card when biometric authorisation fails, or to allow for enrolment without using the biometric sensor.

The invention may also include a method of manufacturing a smartcard. This may consist of providing features as in the first aspect. The manufacturing method may also include providing any or all of the optional features discussed above. The method may include programming the processor to function as discussed above. To enhance the distinctions in vibrational patterns and hence allow for greater differences in accelerometer output between cards manufactured using the same process that are exposed to identical movements, then the manufacturing method may include varying the location of the accelerometer and/or adding mass/stiffness elements with differing characteristics and/or at differing locations to the cards so that each individual card has a unique vibration pattern. The method may optionally include adding a mass and/or stiffness element to the card, for example on a circuit board of the card, with the mass and/or stiffness element being selected from a set of elements with differing mass and/or stiffness characteristics. This allows for the added mass and/or stiffness element to be placed at the same location, which can allow for easier manufacture, whilst ensuring variable effects on the movement of the card since the mass and/or stiffness of the added element will vary. Alternatively or additionally a mass and/or stiffness element may be added to the card at a location that varies for each card. This could use an identical mass and/or stiffness element for each card, or the mass and/or stiffness element being selected from a set of elements with differing mass and/or stiffness characteristics.

In yet a further aspect, the present invention may also provide a computer programme product comprising instructions that, when executed on a processor in a smartcard as described above, will cause the processor to detect movements of the smartcard using the accelerometer, identify an authorised user of the smartcard via the biometric sensor, and permit access to one or more secure feature(s) of the smartcard based on the movements sensed by the accelerometer and authentication of the user's identity via the biometric sensor. The instructions may be arranged to cause the processor to operate in accordance with any or all of the optional and preferred features discussed above, and the smartcard may have corresponding features taken from any of those features discussed above.

### BRIEF DESCRIPTION OF THE DRAWINGS

Certain preferred embodiments of the present invention will now be described in greater detail, by way of example only and with reference to the accompanying drawings, in which:

FIG. 1 a circuit for a smartcard incorporating an accelerometer along with a biometric sensor in the form of a fingerprint scanner;

FIG. 2 illustrates a smartcard with an external housing; and

FIG. 3 shows an example laminated type smartcard.

### DETAILED DESCRIPTION

By way of example the invention is described in the context of a card that uses contactless technology and, in the illustrated embodiment, uses power harvested from the reader. These features are envisaged to be advantageous features of the proposed movement sensitive smartcards, but are not seen as essential features. The smartcard may hence alternatively use a physical contact and/or include a battery providing internal power, for example.

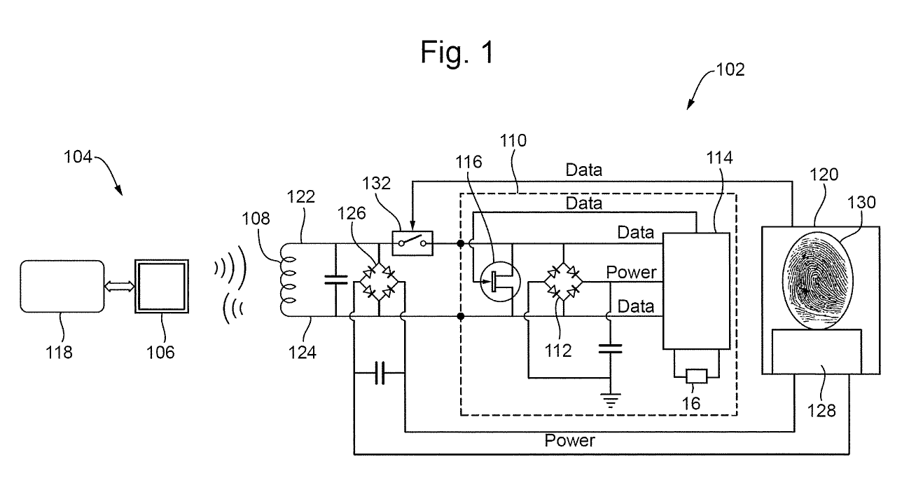

FIG. 1 shows the architecture of a smartcard 102 with the proposed accelerometer 16. A powered card reader 104 transmits a signal via an antenna 106. The signal is typically 13.56 MHz for MIFARE® and DESFire® systems, manufactured by NXP Semiconductors, but may be 125 kHz for lower frequency PROX® products, manufactured by HID Global Corp. This signal is received by an antenna 108 of the smartcard 102, comprising a tuned coil and capacitor, and then passed to a communication chip 110. The received signal is rectified by a bridge rectifier 112, and the DC output of the rectifier 112 is provided to processor 114 that controls the messaging from the communication chip 110.

A control signal output from the processor 114 controls a field effect transistor 116 that is connected across the antenna 108. By switching on and off the transistor 116, a signal can be transmitted by the smartcard 102 and decoded by suitable control circuits 118 in the reader 104. This type of signalling is known as backscatter modulation and is characterised by the fact that the reader 104 is used to power the return message to itself.

The accelerometer 16 is connected in an appropriate way to the processor 114. The accelerometer 16 can be a Tri-axis Digital Accelerometer as provided by Kionix, Inc. of Ithaca, N.Y., USA and in this example it is the Kionix KXCJB-1041 accelerometer. The accelerometer senses movements of the card and provides an output signal to the processor 114, which is arranged to detect and identify movements that are associated with required operating modes on the card as discussed below. This includes activating secure features of the card, which can be done based on a movement or sequence of movements and optionally is done in conjunction with biometric authorisation. The accelerometer 16 may be used only when power is being harvested from the powered card reader 104, or alternatively the smartcard 102 may be additionally provided with a battery (not shown in the Figures) allowing for the accelerometer 16, and also the related functionalities of the processor 114 and other features of the device to be used at any time.

A fingerprint authentication engine 120 is connected to the processor 114 in order to allow for biometric authentication of the user based on a finger or thumb print. The fingerprint authentication engine 120, can be powered by the antenna 108 so that the card is a fully passive smartcard 102. In that case the fingerprint identification of an authorised user is only possible whilst power is being harvested from the card reader 104. In an alternative arrangement the smartcard 102 may be additionally provided with a battery (not shown in the Figures) allowing for the fingerprint authentication engine 120, and also the related functionalities of the processor 114 to be used at any time.

As used herein, the term “passive smartcard” should be understood to mean a smartcard 102 in which the communication chip 110 is powered only by energy harvested from an excitation field, for example generated by the card reader 118. That is to say, a passive smartcard 102 relies on the reader 118 to supply its power for broadcasting. A passive smartcard 102 would not normally include a battery, although a battery may be included to power auxiliary components of the circuit (but not to broadcast); such devices are often referred to as “emi-passive devices”.

Similarly, the term “passive fingerprint/biometric authentication engine” should be understood to mean a fingerprint/biometric authentication engine that is powered only by energy harvested from an excitation field, for example the RF excitation field generated by the card reader 118.

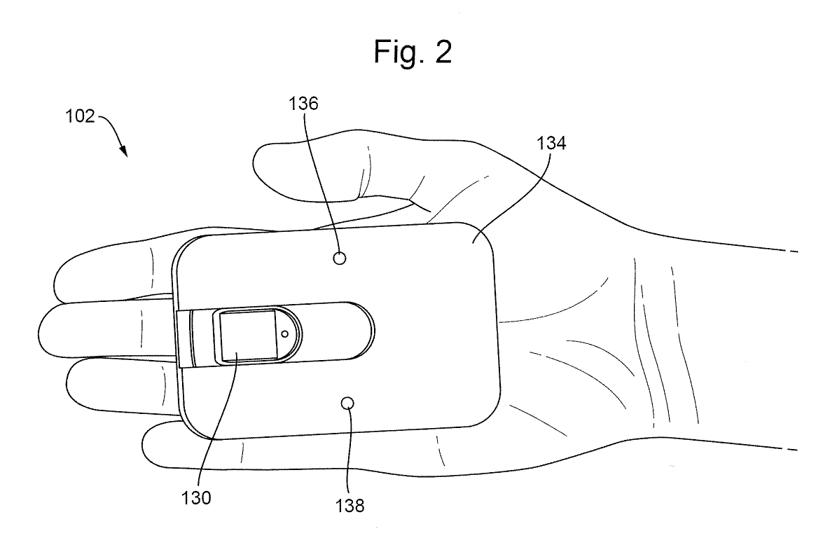

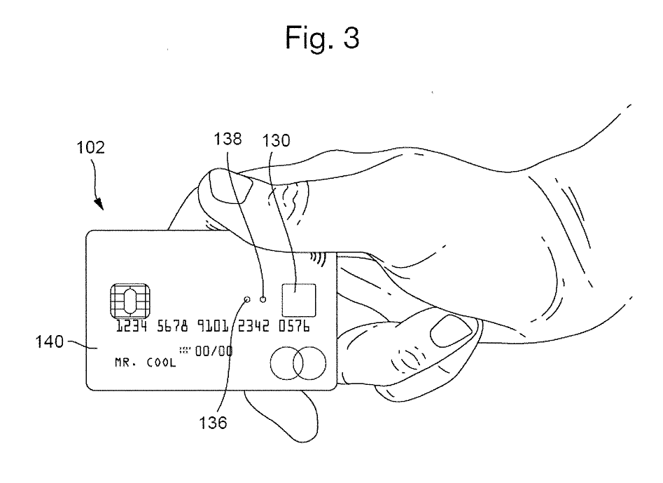

It should be noted that in alternative embodiments battery powered and hence non-passive smartcards may be provided and may have the same features in relation to the accelerometer, fingerprint sensor and so on. With these alternatives the smartcard can have the same features aside from that the use of harvested power is replaced by the power from a battery that is contained within the card body. The card body can be a card housing 134 as shown in FIG. 2 or a laminated card body 140 as shown in FIG. 3.

The antenna 108 comprises a tuned circuit including an induction coil and a capacitor, which are tuned to receive an RF signal from the card reader 104. When exposed to the excitation field generated by the reader 104, a voltage is induced across the antenna 108.

The antenna 108 has first and second end output lines 122, 124, one at each end of the antenna 108. The output lines of the antenna 108 are connected to the fingerprint authentication engine 120 to provide power to the fingerprint authentication engine 120. In this arrangement, a rectifier 126 is provided to rectify the AC voltage received by the antenna 108. The rectified DC voltage is smoothed using a smoothing capacitor and supplied to the fingerprint authentication engine 120.

The fingerprint authentication engine 120 includes a fingerprint processor 128 and a fingerprint reader 130, which can be an area fingerprint reader 130 mounted on a card housing 134 as shown in FIG. 2 or fitted so as to be exposed from a laminated card body 140 as shown in FIG. 3. The card housing 134 or the laminated body 140 encases all of the components of FIG. 1, and is sized similarly to conventional smartcards. The fingerprint authentication engine 120 can be passive and hence powered only by the voltage output from the antenna 108, or there may be battery power as mentioned above. The fingerprint processor 128 comprises a microprocessor that is chosen to be of very low power and very high speed, so as to be able to perform biometric matching in a reasonable time.

The fingerprint authentication engine 120 is arranged to scan a finger or thumb presented to the fingerprint reader 130 and to compare the scanned fingerprint of the finger or thumb to pre-stored fingerprint data using the fingerprint processor 128. A determination is then made as to whether the scanned fingerprint matches the pre-stored fingerprint data. In a preferred embodiment, the time required for capturing a fingerprint image and authenticating the bearer of the card 102 is less than one second.

If a biometric match is determined and/or if appropriate movements are detected via the accelerometer 16, then the processor 114 takes appropriate action depending on its programming. In this example a fingerprint authorisation process and optionally a further authentication via the accelerometer 16 is required to enable use of the smartcard 104 with the contactless card reader 104. Thus, the communication chip 110 is only authorised to transmit a signal to the card reader 104 when a fingerprint match is made and, in some cases, this authorisation may also require an added layer of authentication from accelerations detected by the accelerometer 16. Thus the processor 114 may only authorise the communication chip 110 to transmit if there is both a biometric match and a match between a movement pattern detected by the accelerometer 16 with a movement pattern enrolled on the card 102. The communication chip 110 transmits the signal by backscatter modulation.

The processor 114 receives the output from the accelerometer 16 and this allows the processor 114 to determine what movements of the smartcard 102 have been made. The processor 114 identifies pre-set movements that are linked with required changes to the operating mode of the smartcard 102. As discussed above, the movements may include any type of or combination of rotation, translation, acceleration, jerk, impulse and other movements detectable by the accelerometer 16.

The movements detected by the accelerometer 16 are further influenced by the construction and geometry of the smartcard 102. For example, a smartcard 102 with a housing 134 as in FIG. 2 will behave differently to a smartcard 102 with a laminated body 140 as in FIG. 3 in terms of their natural frequency and their dynamic reaction to a given movement. The same will apply to differently manufactured cards of the same basic type, so that laminated cards produced by different manufacturers and or by different processes will react differently.

This means that the use of an extra layer of authentication requiring movements detected by the accelerometer 16 to match movements enrolled by the accelerometer 16 is very powerful. If a “fake” card is produced fraudulently and the fraudster has managed to copy data concerning the user's movement patterns, with this data being “injected” into the microprocessor of the “fake” card, the resonance of the new card is different from the original card, so therefore it cannot be hacked and if the fraud involves switching a genuine card for a fake of similar appearance but different construction (for example, this might be common in the case of access or ID cards) then the fake will be found out since the authorised user will find that their own card is inoperable and notify the issuing authority by requesting a new card. If another user tries to use the original card by following the owner's tap sequence, the manner in which the fraudulent user holds the card (after successfully creating a false biometric acceptance), and his/her tapping mannerisms ultimately create a different resonance. Even if the same sequence of movements is made, the accelerometer 16 will detect movements with different characteristics if the card or the manner of holding the card is different in any way. Thus, movement patterns enrolled via the accelerometer 16 will be unique to both the user and to the individual smartcard 102.

The movement patterns enrolled via the accelerometer 16 may be stored in a memory at the card 102 (for example as a part of the processor 114) and/or in an external database. Since the accelerometer output signal for the movement patterns can be unique to each card then it unlike biometric data the risk to security from permitting the data to be stored off the card is less, and an additional check on the authenticity of the card itself can be performed by checking the accelerometer data in an external database with accelerometer data on the card.

The operating modes that the processor 114 activates or switches to in response to an identified movement associated with the required change in operating mode may include any mode of operation as discussed above, including turning the card on or off, activating secure aspects of the card 102 such as contactless payment and/or communications with the card reader 104, or changing the basic functionality of the card 102 for example by switching between operating as an access card, a payment card, a transportation smartcard, switching between different accounts of the same type (e.g. two bank accounts), switching between communications protocols (such as blue tooth, Wifi, NFC) and/or activating a communication protocol, activating a display such as an LCD or LED display, obtaining an output from the smartcard 102, such as a one-time-password or the like, or prompting the card 102 to automatically perform a standard operation of the smartcard 102. It will be appreciated that the smartcard 102 can readily be programmed with any required characteristics in terms of the action taken in reaction to events detected by the accelerometer 16.

The processor 114 has a learn mode to allow for the user to specify which movements (including combinations of movements) should activate particular operating modes. In the learn mode the processor 114 prompts the user to make the desired sequence of movements, and to repeat the movements for a predetermined set of times. These movements are then allocated to the required operating mode. The processor 114 can implement a dropped card mode and/or a biometric failure back up mode as discussed above.

In some circumstances, the owner of the biometric smartcard 102 may suffer an injury resulting in damage to the finger that has been enrolled on the card 102. This damage might, for example, be a scar on the part of the finger that is being evaluated. Such damage can mean that the owner will not be authorised by the card 102 since a fingerprint match is not made. In this event the processor 114 may prompt the user for a back-up identification/authorisation check via a sequence of movements. The user can hence have a “password” entered using movements of the card to be used in the event that the biometric authorisation fails.

After such a back-up authorisation the card 102 could be arranged to be used as normal, or it could be provided with a degraded mode in which fewer operating modes or fewer features of the cards 102 are enabled. For example, if the smartcard 102 can act as a bank card then the back-up authorisation might allow for transactions with a maximum spending limit lower than the usual maximum limit for the card.

It should be apparent that the foregoing relates only to certain embodiments of the present application and the resultant patent. Numerous changes and modifications may be made herein by one of ordinary skill in the art without departing from the general spirit and scope of the invention as defined by the following claims and the equivalents thereof.

We claim:

1. A smartcard comprising:
a processor for controlling operation of the smartcard;
a biometric sensor for identification of an authorised user; and
an accelerometer for sensing movements of the smartcard;
wherein the processor is arranged to permit access to one or more secure feature(s) of the smartcard based on the movements sensed by the accelerometer and authentication of the user's identity via the biometric sensor.

2. A smartcard as claimed in claim 1, wherein the smartcard is arranged so that the user can enroll a movement pattern for later use in authentication of the user's identity as a part of the activation process for the secure feature(s).

3. A smartcard as claimed in claim 2, wherein the processor requires a combination of biometric authorisation and matching of a movement pattern to an enrolled movement pattern before access to the secure feature(s) of the card is permitted.

4. A smartcard as claimed in claim 3, wherein the processor is arranged to receive and record a movement pattern that is to be enrolled to the card by receiving and recording data output from the accelerometer.

5. A smartcard as claimed in claim 3, wherein the processor is arranged to transmit the accelerometer output data produced by the movement pattern from the card during enrolment so that it can be recorded in an external database.

6. A smartcard as claimed in claim 5, comprising at least one added mass/stiffness element intended to provide the smartcard with differing vibration characteristics compared to other smartcards with different mass/stiffness elements so that each individual smartcard has a unique vibration pattern.

7. A smartcard as claimed in claim 1, wherein the smartcard is arranged to allow the user to set their own movements and or combinations of movements and to associate them with particular changes to the operating mode of the smartcard.

8. A smartcard as claimed in claim 7, comprising an added mass/stiffness element intended to provide the smartcard with differing vibration characteristics compared to other smartcards with different mass/stiffness elements so that each individual smartcard has a unique vibration pattern.

9. A smartcard as claimed in claim 1, wherein the accelerometer is a micro-machined accelerometer.

10. A smartcard as claimed in claim 1, wherein the accelerometer is a piezoelectric device.

11. A smartcard as claimed in claim 1 wherein the smartcard is arranged to enable the authorised user to initially enroll their fingerprint onto the smartcard via a fingerprint sensor as the biometric sensor, and to thereafter require an enrolled finger or thumb to be placed on the fingerprint sensor in order to allow the processor to identify the authorised user.

12. A smartcard as claimed in claim 1, wherein in the event of a failure of biometric authorisation or failure to enroll a user via the biometric sensor then the smartcard is arranged to accept a pre-set movement pattern detected via the accelerometer as a back-up for biometric authorisation.

13. A smartcard as claimed in claim 10, wherein in the event of a failure of biometric authorisation or failure to enroll a user via the biometric sensor then the smartcard is arranged to accept a pre-set movement pattern detected via the accelerometer as a back-up for biometric authorisation.

14. A method for controlling a smartcard, the smartcard comprising: a processor for controlling operation of the smartcard; a biometric sensor for identification of an authorised user; and an accelerometer for sensing movements of the smartcard, wherein the method comprises:
detecting movements of the smartcard using the accelerometer and the processor,
identifying an authorised user of the smartcard via the biometric sensor, and
permitting access to one or more secure feature(s) of the smartcard based on the movements sensed by the accelerometer and authentication of the user's identity via the biometric sensor.

15. A method as claimed in claim 14, wherein the movements sensed by the accelerometer are affected by the location of the accelerometer and by the presence of added components acting as mass/stiffness elements so that each individual smartcard has a unique vibration pattern.

16. A method as claimed in claim 14, including using an enrolment mode of the processor and recording biometric data and/or movement pattern data during the enrolment mode, with the recorded data being used for later matching with data provided by the biometric sensor and/or the accelerometer during authentication of the user.

17. A method as claimed in claim 14, wherein the processor requires a combination of biometric authorisation and matching of a movement pattern to an enrolled movement pattern before access to the secure feature(s) of the card is permitted.

18. A method of manufacturing one or more smartcard(s) comprising:
providing the or each smartcard with a processor for controlling operation of the smartcard;
providing the or each smartcard with a biometric sensor for identification of an authorised user; and
providing the or each smartcard with an accelerometer for sensing movements of the smartcard;
wherein the processor is arranged to permit access to one or more secure feature(s) of the smartcard based on the movements sensed by the accelerometer and authentication of the user's identity via the biometric sensor.

19. A method of manufacturing one or more smartcard(s) as claimed in claim 18, comprising manufacturing multiple smartcards using the same process whilst varying the location of the accelerometer and/or adding mass/stiffness elements with differing characteristics and/or at differing locations to the smartcards so that each individual smartcard has a unique vibration pattern.

20. A computer programme product comprising instructions that, when executed on a processor in a smartcard as claimed in claim 1, will cause the processor to detect movements of the smartcard using the accelerometer, identify an authorised user of the smartcard via the biometric sensor, and permit access to one or more secure feature(s) of the smartcard based on the movements sensed by the accelerometer and authentication of the user's identity via the biometric sensor.
